(19) United States
(12) Patent Application Publication
(10) Pub. No.: US 2020/0018451 A1
(43) Pub. Date: Jan. 16, 2020

(54) Light bar for installation in a household electrical appliance, shelf assembly and cooling appliance with such a shelf assembly

(71) Applicant: emz-Hanauer GmbH & Co. KGaA, Nabburg (DE)

(72) Inventors: Manfredi Signorino, Wackersdorf (DE); Martin Brabec, Nabburg (DE); Johann Schenkl, Bodenwoehr (DE)

(73) Assignee: emz-Hanauer GmbH & Co. KGaA, Nabburg (DE)

(21) Appl. No.: 16/508,350

(22) Filed: Jul. 11, 2019

(30) Foreign Application Priority Data
Jul. 11, 2018 (DE) 10 2018 005 481.1

(51) Int. Cl. F21S 4/28; F25D 27/00; F21V 33/00; F21S 8/00; F21V 7/00

(52) U.S. Cl. CPC F21S 4/28; F25D 27/00; F21Y 2103/10; F21S 8/03; F21V 7/005; F21V 33/0044

(57) ABSTRACT

A light bar includes an arrangement of several light elements reciprocally spaced behind one another in the longitudinal bar direction where each light element produces a light beam, a reflection surface formed on a light-impermeable reflector body and producing a diffuse scattering effect where a first portion of the light beam of each light element is directed at the reflection surface, a light-permeable window element at which light produced by the light elements exits the light bar. A second portion of the light beam that is different from the first portion is directed past the reflection surface onto the light exit window. The light radiated by the light bar is composed of a direct light proportion and a scattered light proportion, the relative ratio of which in a suitable configuration of the reflector body and the window element can be different in different radiation directions of the light bar.

### BACKGROUND OF THE INVENTION

### 1. Field of the Invention

The present invention relates generally to a light bar, which is intended to be installed in a household electrical appliance, for example a refrigerator.

### 2. Description of the Prior Art

Domestic refrigerators are typically equipped with a lighting device, which, when the door of the refrigerator is opened, illuminates the interior or at least partial areas thereof, so that a user has a better view of the food items located inside. Apart from surface luminaires, which are installed in a partition wall of the refrigerator interior, bar-like elongated light modules are also known in the prior art, which are mounted on a storage shelf, which is used to store foods and can be removed from the refrigerator if necessary, in the area of one of the shelf edges. The light module radiates its light into a spatial area below the storage shelf, for example, and/or into the storage shelf itself, so that the storage shelf appears to be illuminated. For the prior art in respect of such bar-like light modules reference is made by way of example to DE 10 2005 007 839 A1 and WO 201 3/1 641 63 A1.

Domestic refrigerators are often equipped with one or more pull-out drawers, in which special climatic conditions prevail, which are coordinated to the storage of fresh foods (vegetables, meat, sausage etc.) that spoil easily. The withdrawal extent of such a drawer is occasionally limited, and if an opaque storage shelf is located immediately above the drawer, satisfactory illumination of the drawer by means of conventional lighting solutions can be difficult to realise. The present invention was conceived not only, but in particular with a view to creating a satisfactory solution for the illumination of a product drawer of a domestic refrigerator.

### SUMMARY OF THE INVENTION

According to a first aspect of the invention, a light bar is provided for installation in a household electrical appliance, for example a refrigerator, wherein the light bar comprises an arrangement of a plurality of light elements, in particular in LED construction, arranged behind one another in a mutually spaced manner in a longitudinal bar direction of the light bar, wherein each light element is configured to produce a beam of light. The light bar further comprises a light-impermeable reflector body having a reflection surface, the reflection surface configured to produce a diffusely scattering effect, wherein a first portion of the light beam of each of the plurality of light elements is directed onto the reflection surface, and a light-permeable window element, at which light produced by the light elements exits the light bar. A second portion of the light beam of each of the plurality of light elements different from the first portion is directed in this case past the reflection surface onto the light exit window. In this solution a portion of the light produced by each light element is first scattered at the reflection surface before it exits the light bar through the window element. Another portion of the light travels past the reflection surface directly to the light exit window and can exit the light bar through this. The light radiated by the light bar is accordingly composed of portions which are scattered diffusely by means of reflection on the reflection surface and portions that have passed directly to the light exit window without being scattered previously at the reflection surface.

It has been shown that by such a combination of indirect scattered light portions and direct light portions, satisfactory illumination results can be achieved not only, but in particular also for a pull-out product drawer in a refrigerator. Above all, by suitable configuration of the reflection surface and the window element, influence can be exerted on the composition of the light, which is radiated by the light bar in various directions. With the solution according to the invention, a light bar can thus be realised which—when viewed in a section orthogonal to the longitudinal bar direction of the light bar—radiates light with a relatively higher proportion of indirect scattered light in a first direction and in a second direction, which is offset at an angle of up to around 90 degrees, for example, compared with the first direction, radiates light with a relatively lower proportion of indirect scattered light. On the other hand, the light radiated in the second direction contains a relatively higher proportion of direct light, which is incident directly on the window element without scattering on the reflection surface, than the light radiated in the first direction.

It is possible in this way to combine different illumination objectives successfully. For example, with respect to the light radiated from the light bar in the first direction, it may primarily be a case of avoiding glare effects, which can occur if this light encounters a comparatively glossy surface (for example, a surface on the rear wall of the refrigerator interior or on the rear wall of a product drawer). Such glare effects can be satisfactorily avoided by a comparatively high proportion of indirect scattered light. In the case of the light radiated by the light bar in the second direction, on the other hand, the objective can consist primarily, for example, in achieving the most intense illumination possible and thus good recognisability of the foods that have been placed in a product drawer of the refrigerator. A high proportion of direct light may be required to achieve this objective.

In certain embodiments, when viewed in a section orthogonal to the longitudinal direction of the bar, the first portion and the second portion of the light beam of each light element adjoin one another. In particular, the first portion and the second portion of the light beam fill the entire beam cross section.

In certain embodiments, the first portion and the second portion each comprise at least roughly a fifth or at least roughly a quarter or least roughly a third of the cross section of the light beam. Configurations are conceivable in which the first portion and the second portion each comprise approximately half of the light beam cross section. However, configurations are also possible in which the first portion is greater than the second portion or vice-versa.

In certain embodiments, the light bar—when viewed in a section orthogonal to the longitudinal direction of the bar—has an internal cavity that is closed all around, wherein the light elements are arranged on a circuit board inserted into the internal cavity, in particular with a beam axis of the light beam of each light element at least approximately perpendicular to the board plane of the circuit board.

In certain embodiments, the internal cavity is limited by a cavity surface, which—when viewed in a section orthogonal to the longitudinal direction of the bar—runs in a curve shape at least within the angular range of the light beam of each light element, in particular substantially in the shape of an arc of a circle, curved at a distance from the circuit board. A portion of the cavity surface lying within the angular range of the light beam of each light element is formed in this case in a first partial angular range by the window element, while the reflection surface is arranged within a second partial angular range. In this second partial angular range the cavity surface can be formed directly by the reflection surface. Alternatively it is conceivable that the window element extends into the second partial angular range and in the second partial angular range accordingly borders the internal cavity at least partially. In this alternative configuration the reflector body covers the window element on its outer side facing away from the cavity in the second partial angular range. Where the window element is upstream of the reflection surface, the light of the first portion of the light beam of each light element consequently passes the window element first before it encounters the reflection surface and is scattered diffusely there.

In certain embodiments, a distance of each light element from the cavity surface measured perpendicular to the board plane of the circuit board is greater than a centre distance of consecutive light elements. An adequate mixing of the light of adjacent light elements and thereby an on the whole homogeneous light radiation of the light bar can be achieved by this measure.

In certain embodiments, the reflection surface has a mean roughness depth Rz (according to DIN EN ISO 4287) of at least roughly 0.8 μm or at least roughly 1 μm or at least roughly 1.6 μm. In certain embodiments the mean roughness depth Rz is not more than about 3.5 μm or not more than about 3 μm or not more than about 2.5 μm. In other embodiments the mean roughness depth Rz is in a range between about 5.5 μm and about 15 μm or in a range between about 8 μm and about 12.5 μm. Alternatively or in addition, the desired scatter effect of the reflection surface can be achieved by adjusting a suitable defined gloss level of the reflection surface, in particular if the reflection surface is formed by a lacquered or coated (e.g. anodised, chromium-plated or powder-coated) area of the reflector body. In certain embodiments the reflection surface has a gloss level (according to DIN 67 530/ISO 2813) at a 60° measuring angle of at most about 70 GU or at most about 60 GU or at most about 50 GU or at most about 40 GU or at most about 30 GU or at most about 20 GU or at most about 10 GU (corresponding to a silk gloss, silk matt, matt or even dull matt appearance of the reflection surface).

In certain embodiments, the window element has a light transmission in the visible spectrum in a range between about 80% and about 98%. For example, the light transmission of the window element lies in a range between about 85% and about 95%.

In certain embodiments, the window element and the reflection surface extend substantially over the entire bar length of the light bar. The light bar itself can have a linear extension in the longitudinal bar direction; alternatively it can have a curved progression.

According to another aspect, the invention provides a shelf assembly for the storage of objects, in particular in a domestic refrigerator. The shelf assembly comprises a shelf element, which forms a storage surface for objects on a first flat side, and a light bar of the type explained above mounted on the shelf element. The light bar is arranged on a second flat side of the shelf element lying opposite the first flat side.

In certain embodiments, the shelf element has a quadrangular shape in a plan view of one of the two flat sides, wherein the light bar—when viewed in a direction transverse to the longitudinal bar direction—extends closer along a first of the quadrangular edges than along an opposing second quadrangular edge of the shelf element and the first portion of the light beam of each light element (which is directed onto the reflection surface) lies closer to the first quadrangular edge than the second portion of the light beam (which is directed past the reflection surface onto the light exit window).

According to yet another aspect, the invention provides for a cooling appliance of household equipment, wherein the cooling appliance comprises a product drawer that is movable between an inserted position and a pull-out position, and a cover shelf arranged above the product drawer to cover it, relative to which the product drawer can be withdrawn from the inserted position to the pull-out position. The cover shelf is formed by a shelf assembly of the type explained above.

The invention is explained further below by means of the enclosed drawings.

### BRIEF DESCRIPTION OF THE DRAWINGS

FIG. 1 is a domestic refrigerator in a schematic view according to an exemplary embodiment.

FIG. 2a is a shelf assembly with a light bar according to an exemplary embodiment.

FIG. 2b is the light bar of FIG. 2a in an enlarged and inverted view.

FIG. 3a is a shelf assembly with a light bar according to another exemplary embodiment.

FIG. 3b is the light bar of FIG. 3a.

FIG. 3c is a view of a longitudinal part of the light bar of FIG. 3a.

FIG. 4a is a shelf assembly with a light bar according to yet another exemplary embodiment.

FIG. 4b is the light bar of FIG. 4a.

### DETAILED DESCRIPTION OF THE INVENTION

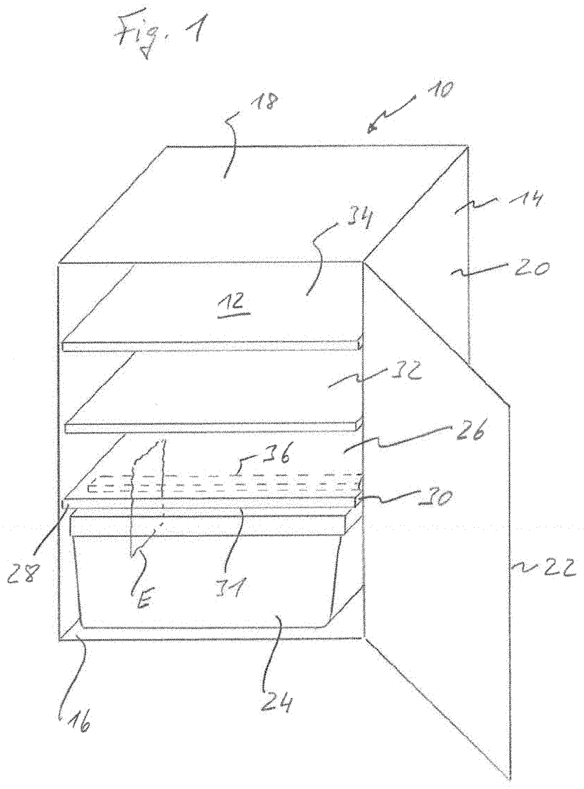

Reference is made first to FIG. 1. The appliance depicted there is generally designated 10. This is a cabinet refrigerator, which is used for the cool storage of foods and provides a cooling space 12 for this, in which temperatures around freezing point or slightly above prevail, for example. In certain embodiments the refrigerator 10 can have a separate freezer compartment to freeze foods. The refrigerator 10 has a cabinet body 14 with a bottom wall 16, a top wall 18, a rear wall, which is not recognisable more closely in FIG. 1, and two side walls 20. The cabinet body 14 forms an access opening framed by the bottom wall 16, the top wall 18 and the two side walls 20, which opening can be closed by a cabinet door 22 hinged pivotably about a vertical pivot axis on one of the side walls 20 and through which the cooling space 12 is accessible.

The cooling space 12 can be equipped with a plurality of built-in components, which are suitable for the storage or deposition of foods. In the example shown in FIG. 1, these built-in components include a pull-out drawer 24, which is shown in its inserted position in the illustration in FIG. 1 and is covered on the upper side by a shelf 26. The shelf forms a surface for foods, which can be stored on the shelf 26. It can be removable from the cooling space 12, but does not move with the drawer 24 when this is pulled out, but remains stationary. The inside of the drawer becomes accessible by pulling out the drawer 24. The shelf 26 has a front shelf edge 28, two shelf side edges 30 opposite one another and a shelf rear edge, which is not shown in greater detail in FIG. 1, and has a generally quadrangular, typically rectangular shelf outline. For goods storage the shelf 26 has at least one shelf element 31. The shelf element 31 is configured, for example, in the manner of a plate and forms a continuous goods storage surface, which can be flat or alternatively can be executed e.g. with recesses for storing bottles. The shelf element 31 is opaque in some embodiments, so that no light can pass through the shelf element 31 into the drawer 24. However, it is not excluded that the shelf element 31 is at least partially transparent and is configured e.g. in the manner of a grate or grid.

In the example in FIG. 1, the built-in components of the refrigerator 10 include other shelves 32, 34, which are likewise intended for the storage of foods.

The refrigerator 10 is equipped with lighting means, which illuminate at least parts of the refrigerator 12 when the door 22 is open. The lighting means include a light bar 36 mounted on the shelf 26 and indicated by a dashed line in FIG. 1, which is used to illuminate the interior of the drawer 24 and is arranged on the underside of the shelf 26 (when viewed in the installed situation). The light bar 36 is executed linearly in the example shown and extends along the front shelf edge 28 of the shelf 26 at a distance of a few centimetres, for example, from the front shelf edge 28. The light bar 36 can be removed from the refrigerator 10 together with the shelf 26 as an assembly (so-called shelf assembly). It is understood that the linear configuration of the light bar 36 shown in FIG. 1 is only by way of example; a curved progression of the light bar is alternatively readily imaginable.

The other figures show different exemplary embodiments of the light bar 36. Identical components or structures or those having an identical effect are provided in all figures with the same reference signs, wherein to differentiate the exemplary embodiments shown in the following figures a different small letter is appended to the reference sign used. Unless otherwise indicated below, reference is made to the respectively preceding implementations to explain the relevant components or structures.

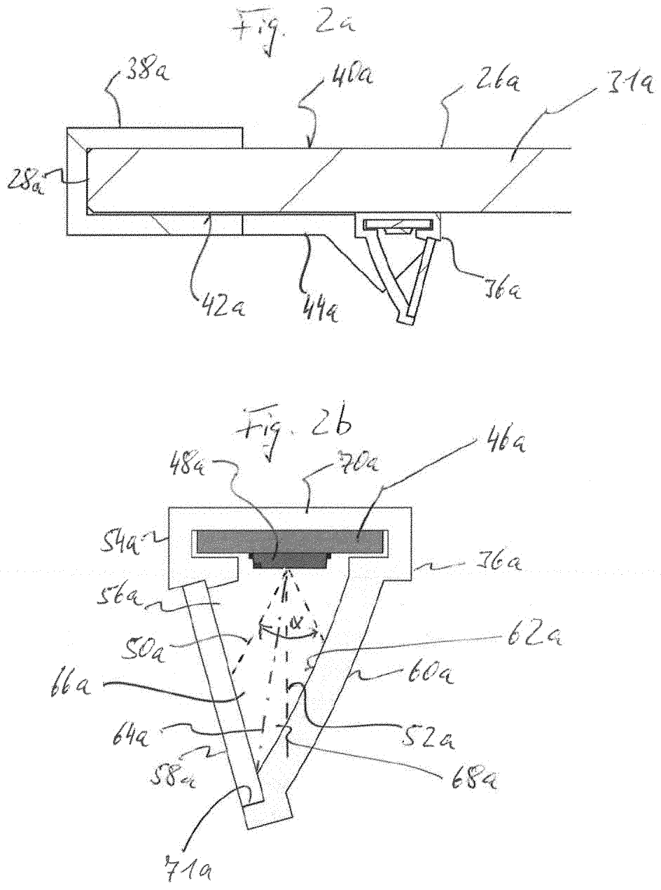

Reference is made next to the exemplary embodiment according to FIGS. 2a and 2b. Here FIG. 2a corresponds to a depiction in a section plane such as is indicated schematically by E in FIG. 1. FIG. 2b shows the light bar 36a of FIG. 2a in an enlarged and inverted view. In FIG. 2a it is recognised that the shelf 26a is provided in the area of front shelf edge 28a with a protective strip 38a serving as edge protection (often termed trim in English technical language), which extends substantially over the entire length of the front shelf edge 28a. The protective strip 38a has a substantially U-shaped cross section and is put onto the shelf element 31a from the front shelf edge 28a, so that in the installed situation of the shelf 26a an upper flat side (first flat side) 40a of the shelf element 31a is covered a little way by one of the longer U-limbs of the protective strip 38a and a lower flat side (second flat side) in the installation situation is covered a little way by the other of the two longer U-limbs of the protective strip 38a. In the area of its strip ends lying opposite in the longitudinal strip direction, the protective strip 38a is executed respectively with a bracket extension 44a, which forms a suitable bracket (e.g. plug-on or clip bracket) for a respective end piece of the light bar 36a. In other words, the light bar 36a extends between the two end-side bracket extensions 44a of the protective strip 38a. An alternative mounting option for the light bar 36a consists in attaching this directly to the shelf element 31a, for example by gluing.

Instead of a U-shaped cross section, the protective strip 38a can alternatively have an approximately L-shaped cross section without the upper of the two longer U-limbs. In this case the shelf element 31a can be glued to the protective strip 38a. Another alternative configuration consists in manufacturing the protective strip 38a not structurally separate from the light bar 36a, but producing the protective strip 38a in one piece connected to a bar housing of the light bar 36a that encloses a cavity all around or at least partially delimits it and to lacquer the component thus created, for example, in order to provide desirable reflection properties of the light bar 36a.

The light bar 36a has an electrical circuit board 46a, on which a plurality of light elements 48a is mounted in the longitudinal bar direction at a distance behind one another. The light elements 48a each form a white light source and are formed by light-emitting diodes, for example. The spacing of consecutive light elements 48a in the longitudinal bar direction of the light bar 36a is a few millimetres up to a few centimetres, for example. The circuit board 46a is arranged on the underside of the shelf 26a, wherein in the example shown the circuit board 46a is oriented with its board plane substantially parallel to the shelf plane of the shelf 26a. It is understood that the circuit board 46a can alternatively be arranged tilted compared with the shelf plane of the shelf 26a. In particular, the circuit board 46a can be tilted compared with the shelf plane of the shelf 26a in such a way that a normal to the board plane of the circuit board 46a, when viewed in the section plane of FIG. 2a, runs obliquely downwards at the front, wherein at the front refers to the shelf front edge 28a.

The light elements 48a each radiate light in a light beam, which is indicated in FIG. 2b by dashed lines and schematically at 50a. The light beam 50a has a beam axis 52a, which is oriented in the example shown substantially orthogonally to the board plane of the circuit board 46a. If the circuit board 46a is oriented substantially parallel to the shelf plane of the shelf 26a, the beam axis 52a then runs substantially orthogonally to the shelf plane of the shelf 26a. If the circuit board 46a is tilted compared with the shelf plane of the shelf 26a, the beam axis 52a runs inclined to the shelf plane of the shelf 26a. In particular, the beam axis 52a can be oriented inclined forwards and downwards in the installed situation of the shelf 26a.

The light beam 50a can have a circular beam cross section or an e.g. elliptical or even asymmetrical cross section deviating from a circular form. In a section plane containing the beam axis 52a and orthogonal to the longitudinal bar direction of the light bar 36a (as shown in FIG. 2b), the beam angle—designated a in FIG. 2b—lies for example in a range of at least 30 degrees or at least 40 degrees or at least 50 degrees or at least 60 degrees or at least 70 degrees or at least 80 degrees and at most 160 degrees or at most 150 degrees or at most 140 degrees or at most 130 degrees or at most 120 degrees. If the light elements 48a each radiate light in a main light beam and one or more side light beams, the light beam 50a describes such a main light beam. In the light beam 50a the intensity of the light can be greatest at the beam axis 52a and decrease continuously in the direction of the beam edge, for example.

The light bar 36a has a bar housing 54a, which has an internal cavity 56a that is enclosed all around when viewed in a section orthogonal to the longitudinal bar direction of the light bar 36a (as in FIG. 2b). The circuit board 46a with the light elements 48a mounted thereon is inserted into the internal cavity 56a and is arranged therein, for example, by suitable form-locking means and/or by gluing and/or other bonding techniques in a positionally stable manner. In the example shown, the bar housing 54a forms an insertion guide, into which the circuit board 46a is inserted on assembly of the light bar 36a and which at the same time assumes a holding function for the circuit board 46a.

Part of the bar housing 54a is formed by an in particular translucent window element 58a that is permeable for the light of the light elements 48a (transmission in the visible range, for example, between roughly 85 and 95%), through which window element the light radiation by the light bar 36a takes place. It is recognised in FIG. 2b that the window element 58a is arranged so that a portion of the light beam 50a of each light element 48a directly encounters the window element 58a. Another part of the bar housing 54a is formed by a reflector body 60a, which on its internal surface facing the internal cavity 56a forms a reflection surface 62a, on which incident light is reflected diffusely. The reflector body 60a is opaque, due to which no light losses occur through the reflector body 60a. The scatter properties of the reflection surface 62a are guaranteed by a suitable surface roughness, for example. Alternatively or in addition, a scatter behaviour of the reflection surface 62a can be achieved by a silk matt or matt surface coating of the reflector body 60a, for example.

It is recognised in FIG. 2b that the remaining portion of the light beam 50a, which does not directly impinge on the window element 58a, first encounters the reflection surface 62a, where it is reflected diffusely. The light of the light bar 36a emerging from the window element 58a is consequently composed of a proportion that impinges directly on the window element 58a from the light elements 48a and a further proportion that first impinges on the reflection surface 62a from the light elements 48a and following diffuse reflection passes to the window element 58a and exits the light bar 36a through this.

A boundary line is indicated by a dotted and dashed line at 64a in FIG. 2b, which illustrates the boundary between that portion of the light beam 50a that directly encounters the window element 58a without previous scattering at the reflection surface 62a, and that portion of the light beam 50a that first impinges on the reflection surface 62a before the light of this portion of the light beam 50a encounters the window element 58a. When viewed in a beam cross section orthogonal to the beam axis 52a, the two portions of the light beam 50a separated by the boundary line 64a each account for at least around a quarter or a third of the beam cross section in some embodiments. In the example shown in FIG. 2b, the portion of the light beam 50a that impinges directly on the window element 58a without previous scattering at the reflection surface 62a (this portion is designated 66a) is smaller when viewed in the beam cross section than the portion of the light beam 50a that first encounters the reflection surface 62a (the latter portion is designated 68a). The beam axis 52a lies in the portion 68a of the light beam 50a.

By suitable configuration of the window element 58a and the reflector body 60a, in particular by suitable adjustment of the relative magnitudes of the light beam portions 66a, 68a relative to one another, a desired radiation characteristic of the lightbar 36a can be achieved, in which—in the section plane in FIG. 2b—radiation substantially exclusively of scattered light occurs in a direction parallel to the shelf plane of the shelf 26a, and in a direction within the angular range of the light beam portion 66a radiation at least mostly of direct light takes place, which has impinged directly on the window element 58a without previous scattering on the reflection surface 62a. It is thus possible to illuminate diffusely the areas of a product drawer (e.g. the drawer 24 in FIG. 1) lying further back, and on the other hand to illuminate the areas of the drawer lying further forward increasingly by direct light.

In certain embodiments a lens element can be arranged in the light path between the light elements 48a and the bar housing 54a (specifically the window element 58a and the reflector body 60a), which lens element is used to increase or reduce the divergence of the light radiated by the light elements 48a. Although the light beam 50a emitted by the light elements 48a is changed by such a lens element to a stepped beam, a portion of the resulting stepped light beam still impinges directly on the window element 58a, while another portion (remaining portion) first encounters the reflection surface 62a.

The reflector body 60a in the example shown in FIG. 2b is a one-piece part of a housing main body 70a of the bar housing 54a, which is executed with suitable bracket formations (here an insertion guide) for the circuit board 46a. It is understood that in other embodiments the bar housing 54a can have a bracket body for the circuit board 46a that is separate from the reflector body 60a. The housing main body 70a is a surface-coated aluminium extrusion, for example, or can be executed as an injection-moulded or extruded plastic component. The reflection surface 62a in certain embodiments is formed by a white material. The housing main body 70a has a window opening 71a, into which the window element 58a produced as a separate component is inserted.

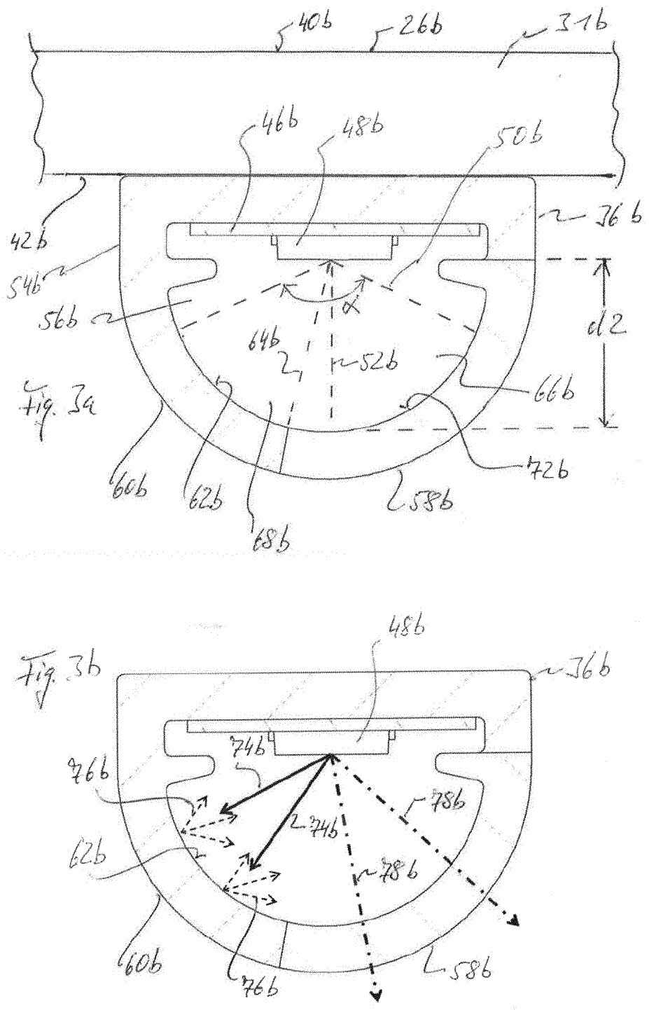

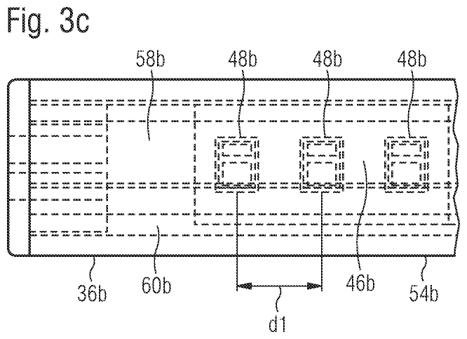

Reference is now made to the exemplary embodiment of FIGS. 3a to 3c. The light bar 36b shown there differs from the light bar 36a of FIGS. 2a, 2b due to a substantially kink- and step-free configuration of the cavity surface (designated 72b) bordering the internal cavity 56b at least within the angular range of the light beam 50b, thus where the light beam 50b impinges on the cavity surface 72b. In this angular range in the example shown—when viewed in the bar cross section—the cavity surface 72b is configured with an at least approximately circular progression, wherein the centre of the circle lies on or near the beam axis 52b, for example in the area of the apex of the light beam 50b.

Another difference from the exemplary embodiment of FIGS. 2a, 2b consists in the fact that in the light bar 36b of FIGS. 3a to 3c, the beam axis 52b lies inside the light beam portion 66b and outside the light beam portion 68b; the light beam portion 66b extends in the bar cross section over a greater angular range than the light beam portion 68b, in contrast to the exemplary embodiment according to FIGS. 2a, 2b, where the light beam portion 66a extends over a smaller angular range than the light beam portion 68a.

The window element 58b can be a constituent of the bar housing 54b that is connected in one piece to the reflector body 60b. For example, the bar housing 54b can be manufactured in a two-component injection moulding process or a two-component extrusion process from plastic material. Here a first plastic material, which guarantees the desired light permeability of the window element 58b, can be used for the window element 58b, while for the remaining areas of the bar housing 54b (including the reflector body 60b), another, light-impermeable plastic material can be used.

The reflection surface 62b in the exemplary embodiment of FIGS. 3a to 3c forms part of the cavity surface 72b.

The centre distance of consecutive light elements 48b measured in the longitudinal bar direction of the light bar 36b—which distance is designated by d1 in FIG. 3c—is smaller than the radial distance between the light elements 48b and the reflection surface 62b (designated d2 in FIG. 3a). By adhering to the stipulation d2>d1 good homogenisation of the light radiated by the light elements 48b in the longitudinal bar direction is achievable. If the distance d1 were selected to be significantly greater than the measurement d2, it could not be excluded that marked variations in the brightness of the light radiated by the light bar 36b manifest themselves in the longitudinal bar direction.

FIG. 3b illustrates the functional principle of the light bar according to the invention. Solid arrows 74b illustrate light rays that are radiated by a light element 48b in the direction of the reflection surface 72b and are scattered diffusely on their impingement on the reflection surface 62b. The resulting scattered light rays are indicated by dashed lines at 76b. In contrast, dashed and dotted arrows 78b illustrate light rays that are radiated by the relevant light element 48 in the direction of the window element 58b and experience no reflection at the reflection surface 62b before they exit the light bar 36b.

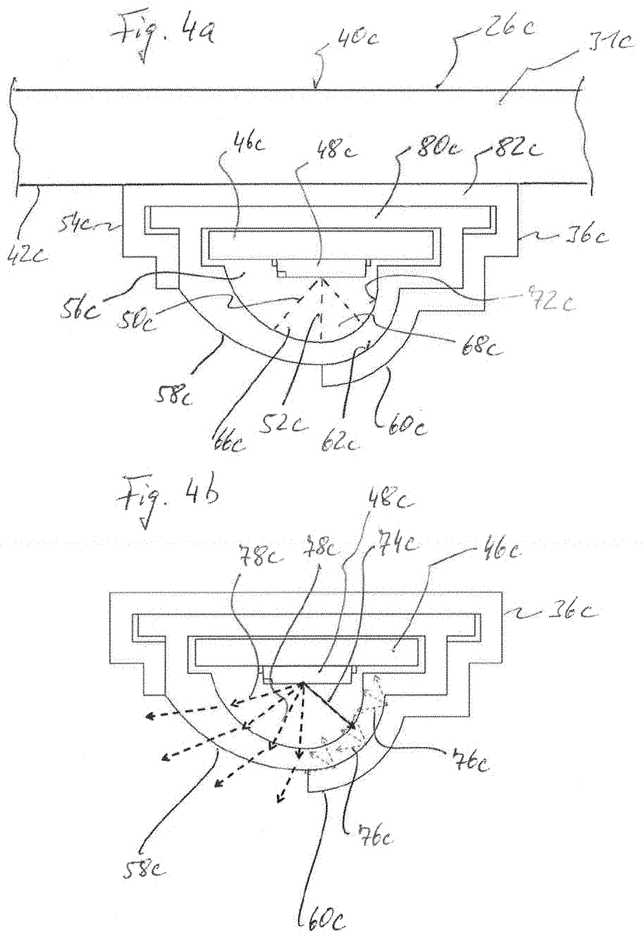

The exemplary embodiment of FIGS. 4a, 4b differs from the previous exemplary embodiments due to the configuration of the bar housing 54c of the light bar 36c. The bar housing 54c is executed in multiple parts and comprises an internal housing part 80c and an external housing part 82c. The internal cavity 56c is formed in the internal housing part 80c, which accordingly encloses the internal cavity 56c all around when viewed in the bar cross section. The internal housing part 80c forms the window element 58c at the same time and can accordingly be formed as a whole from the same light-permeable (plastic) material from which the window element 58c is formed. The external housing part 82c encloses the internal housing part 80c on a portion of its external circumference (again when viewed in the bar cross section) and is pushed or plugged onto the internal housing part 80c in the longitudinal bar direction, for example, and held on the internal housing part 80c by a snap or latch connection. The external housing part 82c forms the reflector body 60c and can be formed accordingly as a whole from the same light-impermeable material from which the reflector body 60c is formed.

Because the internal housing part 80c extends with the window element 58c into the angular range of the light beam portion 68c, the light rays of the light beam portion 68c first pass through the window element 58c before they encounter the reflection surface 62c and are reflected there diffusely. The reflection surface 62c accordingly forms no part of the cavity surface 72c in the exemplary embodiment of FIGS. 4a, 4b, but lies outside this.

Another difference from the previous exemplary embodiments is that the beam axis 52c lies substantially on the boundary line between the two light beam portions 66c, 68c.

FIG. 4b illustrates in turn—similar to FIG. 3b—direct light rays 78c, which are radiated by one of the light elements 48c inside the angular range of the light beam portion 66c (and which are accordingly not scattered on the reflection surface 62c), and a light ray 74c, which is radiated by the relevant light element 48c within the angular range of the light beam portion 68c in the direction of the reflection surface 62c.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A light bar for installation in a household electrical appliance, for example a refrigerator, comprising:
an arrangement of a plurality of light elements arranged mutually spaced behind one another in a longitudinal bar direction of the light bar, wherein each of the plurality of light elements configured to produce a light beam;
a light-impermeable reflector body having a reflection surface, the reflection surface configured to produce a diffusely scattering effect, wherein a first portion of the light beam of each of the plurality of light elements is directed at the reflection surface; and
a light-permeable window element, at which light produced by the plurality of light elements exits the light bar, wherein a second portion of the light beam different from the first portion is directed past the reflection surface to the light exit window.

2. The light bar according to claim 1, wherein when viewed in a section orthogonal to the longitudinal bar direction, the first portion and the second portion of the light beam of each light element adjoin one another.

3. The light bar according to claim 1, wherein the first portion and the second portion each comprise at least about a fifth or at least about a quarter or at least about a third of the cross section of the light beam.

4. The light bar according to claim 1, wherein the light bar—when viewed in a section orthogonal to the longitudinal bar direction—has an internal cavity that is closed all around and the plurality of light elements are arranged on a circuit board inserted into the internal cavity, in particular with a beam axis of the light beam of each light element that is at least approximately perpendicular to the board plane of the circuit board.

5. The light bar according to claim 4, wherein the internal cavity is limited by a cavity surface, which, when viewed in a section orthogonal to the longitudinal direction of the bar, runs in a curve shape at least within the angular range of the light beam of each light element, in particular substantially in the shape of an arc of a circle, curved at a distance from the circuit board, wherein a portion of the cavity surface lying within the angular range of the light beam of each light element is formed in a first partial angular range by the window element and the reflection surface is arranged within a second partial angular range.

6. The light bar according to claim 5, wherein the cavity surface is formed in the second partial angular range by the reflection surface.

7. The light bar according to claim 5, wherein the window element extends into the second partial angular range and the reflector body within the second partial angular range covers the window element on its outer side facing away from the cavity.

8. The light bar according to claim 5, wherein a distance of each light element from the cavity surface measured perpendicular to the board plane of the circuit board is greater than a centre distance of consecutive light elements.

9. The light bar according to claim 1, wherein the reflection surface has a mean roughness depth Rz of at least around 0.8 μm or at least roughly 1 μm or at least roughly 1.6 μm and/or a gloss level at a 60° measuring angle of at most about 70 GU or at most about 60 GU or at most about 50 GU or at most about 40 GU or at most about 30 GU or at most about 20 GU or at most about 10 GU.

10. The light bar according to claim 1, wherein the window element has a light transmission in the visible spectrum in a range between about 80% and about 98%.

11. The light bar according to claim 1, wherein at least one of the following is satisfied:
(i) the window element and the reflection surface extend substantially over the entire bar length of the light bar;
(ii) the light bar extends linearly in its longitudinal bar direction; or
(iii) the light bar is curved.

12. A shelf assembly for storing objects, comprising a shelf element, which forms a storage surface for objects on a first flat side, and a light bar mounted on the shelf element, wherein the light bar is arranged on a second flat side of the shelf element lying opposite the first flat side, the light bar comprising:
an arrangement of a plurality of light elements arranged mutually spaced behind one another in a longitudinal bar direction of the light bar, wherein each of the plurality of light elements configured to produce a light beam;
a light-impermeable reflector body having a reflection surface, the reflection surface configured to produce a diffusely scattering effect, wherein a first portion of the light beam of each of the plurality of light elements is directed at the reflection surface; and
a light-permeable window element, at which light produced by the plurality of light elements exits the light bar, wherein a second portion of the light beam different from the first portion is directed past the reflection surface to the light exit window.

13. The shelf assembly according to claim 12, wherein the shelf element in a top view onto one of the two flat sides has a quadrangular outline and the light bar, when viewed in a direction transverse to the longitudinal bar direction, extends closer along a first of the quadrangular edges than along an opposing second quadrangular edge of the shelf element and the first portion of the light beam of each light element lies closer to the first quadrangular edge than the second portion of the light beam.

14. A cooling appliance of household equipment, comprising a product drawer that is movable between an inserted position and a pull-out position and a covering shelf arranged above the product drawer to cover it, relative to which the product drawer can be withdrawn from the inserted position into the pull-out position, wherein the covering shelf is formed by a shelf assembly comprising a shelf element, which forms a storage surface for objects on a first flat side, and a light bar mounted on the shelf element, wherein the light bar is arranged on a second flat side of the shelf element lying opposite the first flat side, the light bar comprising:
an arrangement of a plurality of light elements arranged mutually spaced behind one another in a longitudinal bar direction of the light bar, wherein each of the plurality of light elements configured to produce a light beam;
a light-impermeable reflector body having a reflection surface, the reflection surface configured to produce a diffusely scattering effect, wherein a first portion of the light beam of each of the plurality of light elements is directed at the reflection surface; and
a light-permeable window element, at which light produced by the plurality of light elements exits the light bar, wherein a second portion of the light beam different from the first portion is directed past the reflection surface to the light exit window.
